(19) United States
(12) Patent Application Publication
(10) Pub. No.: US 2007/0111085 A1
(43) Pub. Date: May 17, 2007

(54) Electrocatalyst for fuel cell-electrode, membrane-electrode assembly using the same and fuel cell

(76) Inventors: Masatoshi Sugimasa, Tokai (JP); Haruo Akahoshi, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/529,331

(22) Filed: Sep. 29, 2006

(30) Foreign Application Priority Data
Nov. 15, 2005 (JP) 2005-329553

(51) Int. Cl. H01M 4/86; H01M 4/92; H01M 4/96; H01M 8/10

(52) U.S. Cl. 429/42; 429/44; 429/30

(57) ABSTRACT

In An electrocatalyst for an electrode in a fuel cell, it comprises a support, a catalytic metal particle supported on the support, an intermediate made of a metal different from plutinu formed on the support, and a solid polymer electrolyte layer formed on the support. The catalytic metal particle is formed on an exposed surface of the intermediate.

### CLAIM OF PRIORITTY

The present application claims priority from Japanese application serial no. 2005-329553, filed on Nov. 15, 2005, the content of which is hereby incorporated by reference into this application.

### FIELD OF THE INVENTION

The present invention relates to an electrocatalyst and a fuel cell provided with a membrane-electrode assembly (hereinafter, abbreviated to “MEA”) including an anode, an electrolyte and a cathode.

### BACKGROUND OF THE INVENTION

A fuel cell includes, as essential components, a solid or liquid electrolyte, and two electrodes, namely, an anode and a cathode, for inducing an electrochemical reaction. The fuel cell is a power generator capable of converting the chemical energy of a fuel directly at high efficiency into electric energy by the agency of an electrocatalyst. The fuel is hydrogen produced through the chemical reaction of a fossil fuel, water, methanol, an alkaline metal hydride or hydrazine, which is a liquid or a solution in an ordinary environment, or dimethyl ether, namely, a compression liquefied gas. Air or oxygen gas is used as an oxidizer.

The fuel is electrochemically oxidized at the anode. The oxygen is reduced at the cathode. Consequently, an electrical potential difference is produced between the anode and the cathode. When an external circuit, namely, a load, is connected to the anode and the cathode, ionic migration occurs in the electrolyte to supply electric energy to the external circuit.

The fuels of direct methanol fuel cells (hereinafter, abbreviated to “DMFCs”) using a liquid fuel, metal hydride fuel cells and hydrazine fuel cells have a high volume energy density. Therefore, those fuel cells are attractive power supplies for portable devices. DMFCs using methanol, which is expected to be produced from biomass in the near future, as a fuel are ideal power supplies.

Inventions relating to the improvement of the performance of electrode catalysts are disclosed in JP-A Nos. 2002-1095, 2002-305000 and 2003-93874.

Platinum (Pt) is a catalytic metal indispensable to a solid polymer fuel cell to be used in an environment of ordinary temperatures. On the other hand, the reduction of the necessary amount of expensive Pt for the solid polymer fuel cell is an important problem to be solved to achieve the practical application of the solid polymer fuel cell. Generally, small Pt particles are attached to a support to increase the specific surface area of Pt, namely, the surface area per unit weight of Pt. Only Pt atoms exposed on the surface of the support contribute to catalysis, and Pt atoms coated with the electrolyte or the like do not contribute to catalysis.

Accordingly, the present invention is to provide a electrocatalyst capable of increasing the amount of effective catalytic metal that contributes to catalysis, of improving the economic effect of the catalytic metal, of reducing the necessary amount of the catalytic metal and of exercising high catalytic activity.

In addition, the present invention is to provide a fuel cell including a MEA provided with the electrocatalyst according to the present invention and having an improved output density.

### SUMMARY OF THE INVENTION

An electrocatalyst for an electrode in a fuel cell, comprising: a support, a catalytic metal particle supported on the support, an intermediate made of a metal different from platinum the catalytic metal particle formed on the support, and a solid polymer electrolyte layer formed on the support; wherein the catalytic metal particle is attached on an exposed surface of the intermediate.

According to the present invention, the ratio of the amount of the effective catalytic metal particle that contributes to catalysis to the total amount of the catalytic metal particle is increased and the fuel cell provided with the electrocatalyst has a high output density.

### BRIEF DESCRIPTION OF THE DRAWINGS

FIG. 1 is a diagrammatic view of a fuel cell power supply system including a fuel cell in a preferred embodiment according to the present invention;

FIG. 2 is an exploded perspective view of the fuel cell in the preferred embodiment;

FIG. 3 is a perspective view of a fuel cell power supply with a cartridge holder including the fuel cell in the preferred embodiment;

FIGS. 4A and 4B are typical views of electrocatalyst according to the present invention;

FIGS. 5A, 5B and 5C are plan views of a MEA and diffusion layers according to the present invention;

FIG. 6 is a perspective view of the fuel cell in the preferred embodiment;

FIG. 7 A is a plan view of an assembly of a fuel chamber, an anode plate and a MEA; and

FIG. 8 is a side elevation of a personal digital assistant provided with a fuel cell according to the present invention.

### DETAILED DESCRIPTION OF THE PREFERRED EMBODIMENTS

Features and advantages of the present invention will become more apparent from the following description taken in connection with the accompanying drawing.

A fuel cell module 1 in a preferred embodiment according to the present invention uses methanol as fuel. The fuel is not limited to methanol, hydrogen or gases containing hydrogen may be used as the fuel. The fuel cell generates electric power through the direct conversion of the chemical energy of methanol into electric energy through an electrochemical reaction. A reaction of a methanol solution represented by Expression (1) occurs at an anode. The reaction is a methanol oxidizing reaction to produce carbon dioxide, hydrogen ions and electrons.
CH₃OH+H₂O→CO₂+6H⁺+6e³¹ (1)

Hydrogen ions produced by the oxidation of methanol migrate from the anode to the cathode through an electrolyte and interact with oxygen gas and electrons on the cathode to undergo a reaction expressed by Expression (2) expressing the reduction of oxygen on the cathode. Wherein the oxygen is contained in air and brought to the cathode by diffusing from air.
6H⁺+3/2 O₂+6e⁻→3H₂O (2)

The above-mentioned electrolytic reaction for power generation is an oxidation reaction between methanol and oxygen in terms of a total chemical reaction. It means that carbon dioxide and water are produce by the following expression (3), and is equivalent to a chemical reaction formula showing the burning of methanol.
CH₃OH+3/2 O₂→CO₂+3H₂O (3)

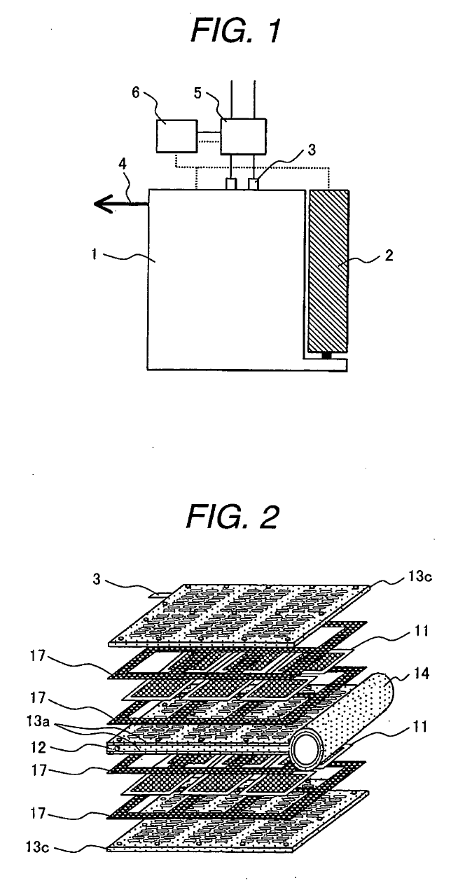

A fuel cell in a preferred embodiment according to the present invention will be detailed below. Referring to FIG. 1, a power supply system includes a fuel cell module 1 in a preferred embodiment according to the present invention, a fuel cartridge 2, output terminals 3, a gas exhaust port 4, a DC-DC converter 5 and a controller 6. Carbon dioxide gas produced at an anode in the fuel cell is exhausted from a fuel chamber 12 (FIG. 2) through the gas exhaust port 4. The fuel contained in the cartridge 2 is fed into the fuel chamber 12 by using the pressure of a high-pressure liquefied gas, a high-pressure gas or a spring. The fuel chamber 12 has been maintained at a pressure higher than the atmospheric pressure by the liquid fuel with the pressure. As the fuel in the fuel chamber 12 is consumed for power generation, the fuel chamber 12 is replenished with the fuel from the fuel cartridge 2. Power generated by the fuel cell module 1 is supplied through the DC-DC converter 5 to a load such as electric equipment. The controller 6 controls the DC-DC converter 5 on the basis of signals representing a residual quantity in the fuel cell and fuel cartridge 2, and signals representing conditions of the DC-DC converter 5, and, as needed, issues a warning signal. Furthermore, as needed, the controller allows the electric equipment as load to indicate the operating conditions of the power supply system, such as an output voltage and output current of the fuel cell module 1 and a temperature of the fuel cell module 1. When the residual quantity of the fuel in the fuel cartridge 2 become below a predetermined threshold, or when the amount of diffused air is outside a predetermined range, power supply from the DC-DC converter 5 to the electric equipment is stopped and a warning device is driven to give a warning by sound, speech, a pilot lamp or characters. Of course, while the power supply system is in a normal operation, the residual fuel in the fuel cartridge 2 represented by a fuel level signal can be displayed on the electric equipment.

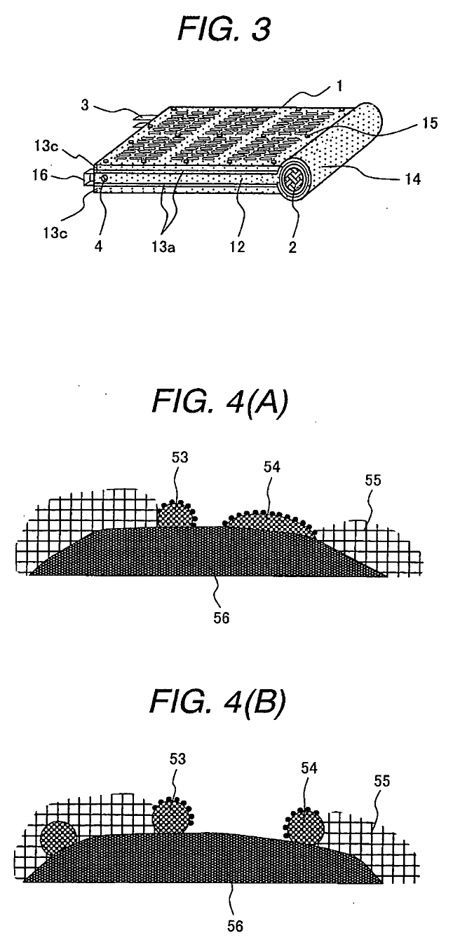

The fuel cell module shown in FIG. 2 comprises the fuel chamber 12 with a fuel cartridge holder 14 and the following fuel cell stack. In the fuel stack, an anode end plate 13a, a gasket 17, MEAs 11 with diffusion layer, a gasket 17 and a cathode end plate 13c are layered on an one side of the fuel chamber 12 in the above-listed order, and also another layered structure of the same as the above mentioned anode end plate 13a, gasket 17, MEAs 11, gasket 17 and cathode end plate 13c is put on another side of the fuel chamber 12. The layered structures and the fuel chamber 12 are fastened together with screws 15 as shown in FIG. 3 so that the layered structures and the fuel chamber 12 are pressurized together with uniform pressure. As shown in FIG. 2, for example, six sheets of MEAs 11 with diffusion layer per one side are disposed in respective plane on both sides of the fuel chamber 12.

FIG. 3 shows the completed fuel cell module 1. In the fuel cell module 1, a plurality of unit cells (for example total number is twelve unit cells; the number is not limited of the above layered structured on both sides of the fuel chamber 12 are connected in series through a connecting terminal 16. Power generated by the fuel cell module 1 is outputted through the output terminals 3.

Members of the fuel chamber 12 have smooth flat surfaces so that the MEAs 11 are pressurized uniformly against the surfaces. The material of the fuel chamber members is not particularly limited so long as the members are insulations for preventing the unit cells from short-circuiting. Suitable materials of the fuel chamber 12 include high-density vinyl chloride resins, high-density polyethylene resins, high-density polypropylene resins, epoxy resins, polyether ether ketone resins, polyether sulfone resins, polycarbonate resins and glass-fiber reinforced resins produced by impregnating glass fiber structures with those resins. The fuel chamber 12 may be formed by processing a sheet of any one of carbon, steels, nickel, light aluminum alloys, light magnesium alloys, intermetallic compounds, such as a Cu—Al intermetallic compound and stainless steels, having nonconducting surfaces or insulated surface coated with a resin.

A material of an insulating sheet used as the anode end plate 13a is not limited particularly so long as the sheet has an insulating property and a flat surface. Suitable sheets are high-density vinyl chloride resin sheets, high-density polyethylene resin sheets, high-density polypropylene resin sheets, epoxy resin sheets, polyether ether ketone resin sheets, polyether sulfone resin sheets, polycarbonate sheets, polyimide resin sheets and glass-reinforced resin sheets produced by impregnating the resins forming the foregoing sheets.

The cathode end plate 13c is provided with threaded holes into which the screws are screed to fasten the components of the fuel cell 1 together.

The MEA 11 contains an anode catalyst and a cathode catalyst. A mixture of Pt particles and Ru particles or Pt—Ru alloy particles are dispersed and supported on a support of carbon powder to form the anode catalyst. Pt particles are dispersed and supported on support of carbon particles to form the cathode catalyst. The anode catalyst and the cathode catalyst can be easily manufactured.

Since catalytic metal such as Pt—Ru alloy particles and Pt particles are in fine particle form, when such a catalytic metal particles are merely provided directly on the surface of the support as before, Pt atoms in the particles are apt to be buried in the solid polymer electrolyte coexisting with the catalytic metal on the support. The resulting buried Pt atoms do not contribute to catalysis and are useless. The surface area of Pt atoms on the support increases with the size reduction of the particle. However even in a fine particle of a diameter on the order of 2 nm, the ratio of atoms exposed on the support to total atoms is on the order of 50%. Practically, the ratio of atoms exposed on the support to total atoms is 30% or below.

In order to cope with the above-mentioned problem, in this embodiment, the surface of the support (it's also referred as base support) is provided with an intermediate (it's also referred as intermediate support). The intermediate is made of a metal different from than the catalytic metal and far larger than the particle size of the catalytic metal so as to be hard to be buried in the solid polymer electrolyte. The catalytic metal particles are deposited in an atomic layer level. Thereby the ratio of the catalytic metal atoms exposed on the support to total catalytic metal increase, and the ratio of the catalytic metal atoms capable of contributing to catalysis increase. As a result, it is possible to reduce the total amount of the catalytic metal while keeping high catalytic activity.

The above-mentioned electrocatalyst according to the present invention, which has high catalytic activity for a fuel cell will be described. FIG. 4A shows, byway of example, an ideal structural model of an electrocatalyst for the electrode of the fuel cell in the preferred embodiment. The electrocatalyst includes catalytic metal particles 53, an intermediate 54, a solid polymer electrolyte 55 and a support 56.

A three-phase interface in which the catalytic metal, the solid polymer electrolyte and a fuel diffusion pathes coexist is important for the electrocatalyst. As shown in FIG. 4A, the intermediate (intermediate support) 54 are in contact with both the solid polymer electrolyte 55 and the support (base support) 56. The catalytic metal particles 53 are deposited in a single-atom layer on the intermediate 54. The electrocatalyst shown in FIG. 4A is the most desirable example. Desirably, the intermediate 54 shown in FIG. 4A is formed by electroplating. An electrode is formed by the following step of mixing a solid polymer electrolyte 55 and a support 56, forming intermediate 54 on the support 56 by electroplating, and depositing catalytic metal particles 53 on the surface of the intermediate 54. By using the electroplating, the intermediate 54 can be formed only on the support 56 having high electronic conductivity because the solid polymer electrolyte 55 has low electronic conductivity.

FIG. 4B shows another possible electrocatalyst of the present invention. In the electrocatalyst shown in FIG. 4B, parts of the intermediate 54 are buried in a solid polymer electrolyte 55. The catalytic metal particles 53 are deposited only on the surfaces of exposed parts of the intermediate 54. The intermediate 54 of the electrocatalyst shown in FIG. 4B, as compared with that of the electrocatalyst shown in FIG. 4A, has many useless parts which is economically disadvantageous. However since the intermediate 54 can be formed by electroless plating or a method using nanoparticles, a process for forming the intermediate 54 has a high degree of freedom. For example, the intermediate 54 can be formed by a simple process of preparing a mixture of nanoparticles of a metal having a proper particle size and the solid polymer electrolyte 55 and supporting the mixture on the support 56. The material of the intermediate 54 is inexpensive as compared with the catalytic metal particles 53. Therefore, the electrocatalyst shown in FIG. 4B is more advantageous in cost than that shown in FIG. 4A.

The material of the catalytic metal particles 53 may be any suitable metal. Preferably, the catalytic metal is Pt or alloys of Pt, because Pt and alloys of Pt have a very high catalytic activity on the oxidation of hydrogen or methanol and the reduction of oxygen. The catalytic activity of the alloys of Pt is greatly dependent on the composition thereof. Therefore, the proper selective determination of the composition of the Pt-containing alloy is very important to provide a catalytic metal capable of exercising high catalytic activity. There are not particular restrictions on the type of the alloys of Pt. It is recommended to use a Pt—Ru alloy having a cocatalyst effect on a CO oxidizing reaction for forming the anode of a solid polymer type fuel cell.

Pt and Ru are noble metals and the ratio of the cost of Pt and Ru to that of the catalyst is very high. Therefore the reduction of the necessary amount of Pt and Ru is desired. In the electrocatalyst shown in FIGS. 4A and 4B, the ratio of the amount of the catalytic metal that contributes to catalysis to the total amount of the catalytic metal is very high. Such catalysis contributing ratio of the catalytic metal is dependent on the thickness of the catalytic metal particles 53. When the atoms of the catalytic metal are arranged in a single atomic layer, the ratio is 100%. Even when the atoms of the catalytic metal are arranged in two or three atomic layers, the ratio is not lower than 50%. Thus the electrocatalyst of the fuel cell of the present invention is excellent in the efficiency of utilization of catalyst as compared with conventional electrocatalysts. The catalysis contributing ratio of the catalytic metal can be determined by various methods. The simplest method has the following steps of: after determining the weight of the catalytic metal through composition analysis, determining the number of atoms of the catalytic metal on the surface by a chemical gas adsorption measuring method, and the resulting calculating the catalysis contributing ratio of the catalytic metal.

Higher catalytic activity can be achieved by using a smaller amount of Pt through the improvement of the ratio of the catalysis contributing ratio of the catalytic metal. A sufficient Pt content of the catalytic metal is in the range of 1 to 50% by weight. It is preferable from the view point of material cost that the Pt content of the catalytic metal is in the range of 10 to 30% by weight.

A deposition method using an electrochemical reaction using a liquid phase is a preferable for depositing Pt or alloys of Pt. A deposition method using an electrochemical reaction can easily control the weight of deposit per unit area and can be easily carried out. A deposition method using an electrochemical reaction may be, for example, the following method. That is a deposition method of depositing Pt through displacement plating after forming an intermediate of a metal having ionization tendency lower than that of Pt; a deposition method of depositing a base metal on the surface of an intermediate by UPD, then displacing the base metal by Pt; a deposition method of adsorbing a reducer such as hydrogen on the surface of an intermediate, then depositing Pt by reduction; or a deposition method of using spontaneous Pt deposition.

There are not particular restrictions on the material of the intermediate 54. Metals are suitable materials of the intermediate 54 in view of forming facility, manufacturing cost and stability. Suitable metals for forming the intermediate 54 are, for example, Pd, Rh, Ir, Ru, Os, Au, Ag, Ni and Co. Metals having high acid resistance, such as Pd, Rh, Ir, Ru, Os and Au are particularly suitable materials of the electrode of a solid polymer fuel cell. It is desirable to enable use inexpensive materials, such as Ag and Ni, for forming the electrode in the future through the improvement of the solid polymer electrolyte.

Electrons are supplied through the intermediate 54 to the catalytic metal particles 53 and hence the intermediate 54 needs to be in contact with the support 56. In this embodiment, the intermediate 54 is held on the support 56 by physical adsorption. Desirably, the intermediate 54 is held on the support 56 by the chemical bond of the intermediate 54 and functional groups lying on the surface of the support 56.

There are not particular restrictions on the shape of the intermediate 54. The intermediate may be a polycrystalline, a single-crystal or an amorphous. The specific surface area of the intermediate 54 is insufficient if the metal content of the intermediate 54 is excessively low. An excessively high metal content of the intermediate 54 increases the cost of the intermediate 54 disadvantageously. A desirable ratio of the amount of the metal of the intermediate 54 to the amount of the electrocatalyst in the range of 10 to 60% by weight, preferably, in the range of 30 to 60% by weight.

When using the electrocatalyst for an electrode of a fuel cell, the solid polymer electrolyte 55 needs to have high proton conduction. It is, for example, Solid polymer electrolytes having main chains to which F (fluorine) is bonded, such as sulfonated fluorocarbon polymers represented by polyperfluorostyrene sulfonic acids and perfluorocarbon sulfonic acids, have high proton conduction. However, since fluorocarbon solid polymer electrolytes are expensive, it is desirable that practical fuel cells use inexpensive hydrocarbon solid polymer electrolytes having main chains to which F is not bonded. Desirable materials are those obtained by sulfonating hydrocarbon polymers, such as polystyrene sulfonic acids, sulfonated polyether sulfones and sulfonated polyether ether ketone polymers, or alkylsulfonated hydrocarbon polymers. A stable fuel cell not subject to the influence of carbon dioxide gas contained in air can be obtained by forming its electrolyte of a material having hydrogen ion conduction. Generally, fuel cells provided with an electrolyte of one of those materials can operate at temperatures not higher than 80° C. Fuel cell capable operating at temperatures in a higher temperature range can be obtained by using a composite electrolyte of a material prepared by dispersing microparticles of an inorganic substance with hydrogen ion conduction into a heat-resistant resin or a sulfonated resin. The inorganic substance is, for exampls, tungsten oxide hydrate, zirconium oxide hydrate or tin oxide hydrate. Particularly, an electrolyte containing a composite electrolyte containing a sulfonated polyether sulfone, a polyether ether ketone or an inorganic substance capable of hydrogen ion conduction is a preferable electrolyte having low methanol permeability as compared with those of electrolyte of polyperfluorocarbon sulfonic acids. The use of an electrolyte having high hydrogen ion conduction and low methanol permeability improves the power generating efficiency of fuel. Thus the fuel cell of the present invention is compact and is capable of generating power for an extended time.

The solid polymer electrolyte 55 needs to be in contact with the support 56 to form a three-phase interface. In this embodiment, the solid polymer electrolyte 55 is brought into contact with the support 56 by physical adsorption. Proton conduction decreases if the solid polymer electrolyte content is excessively low. The fuel and the reaction products cannot disperse satisfactorily if the solid polymer electrolyte content is excessively high. A desirable solid polymer electrolyte content is in the range of 10 to 60% by weight.

In view of stability, conduction and cost, it is preferable the support 56 of the electrode electrocatalyst for the fuel cell is a carbonaceous structure. There are not particular restrictions on the size and morphology of the carbonaceous structure; the carbonaceous structure may be a sheet, a bar, a porous material, particles or fibers. More concretely, the support 56 may be a porous carbon sheet, a carbon paper structure, a graphite structure, a glassine paper structure, a carbon black structure, an activated carbon structure, a carbon fiber structure or a carbon nanotube structure.

When the support 56 is made of a carbonaceous material, it is preferable to modify the surface of the support 56 to provide the support 56 with functional groups for forming chemical bonds. There are many surface modifying methods. A simple surface modifying method heats a carbonaceous structure in a concentrated nitric acid solution or a hydrogen peroxide solution to oxidize the surface of the carbonaceous structure. It is more desirable to modify the surface of the carbonaceous structure with functional groups containing atoms highly adsorptive to metals, such as sulfide atoms, nitrogen atoms or oxide atoms.

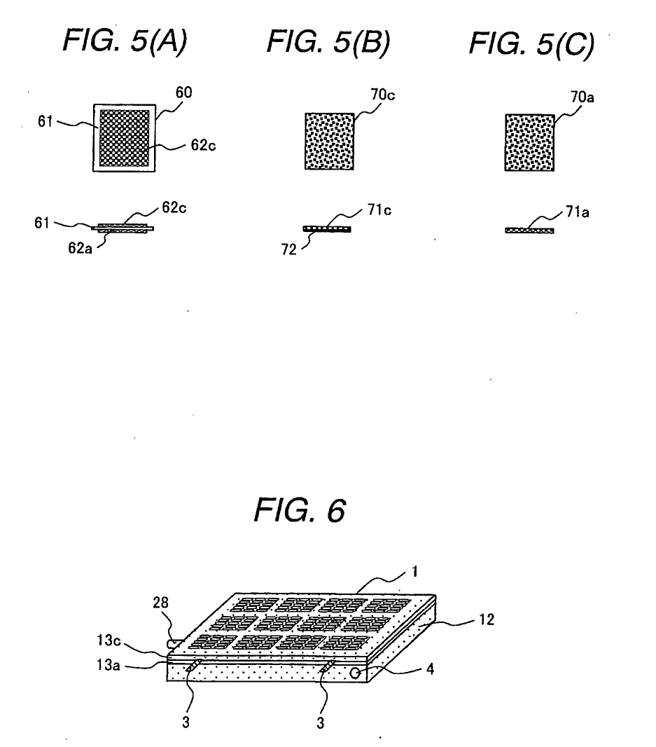

FIG. 5A shows a MEA 60 employed in the fuel cell embodying the present invention. An electrolyte 61 is made of an alkylsulfonated polyether sulfone. An anode 62a is formed by supporting a catalyst containing Pt and Ru on a carbon support (XC72R, Cabot Corporation). A cathode 62c is formed by supporting a catalyst containing Pt on a carbon support (XC72R, Cabot Corporation). A polymer similar to the alkylsulfonated polyether sulfone used for forming the electrolyte and having a sulfonation equivalent weight smaller than that of the electrolyte is used as a binder. When this binder is used, the crossover of water contained in the electrolyte dispersed in the electrode catalyst and methanol is greater than that in the electrolyte, the diffusion of the fuel over the electrode catalyst is promoted and the ability of the electrode is improved.

FIGS. 5B and 5C show a cathode diffusion layer 70c and an anode diffusion layer 70a, respectively. The cathode diffusion layer 70c includes a porous carbon substrate 71c, and a water-repellent layer 72. The water-repellent layer 72 has high water repellency to increase water vapor pressure around the cathode and to prevent the diffusing discharge of produced water vapor and the agglomeration of water. The water-repellent layer 72 is brought into contact with the cathode electrode 62c. There are not particular conditions on contact between the anode diffusion layer 70a and the anode electrode 62a and a porous carbon substrate is used. A porous carbon substrate 71c included in the cathode diffusion layer 70c is conducting. The porous carbon substrate 71c is a woven or nonwoven fabric of carbon fibers, such as a carbon cloth (Toreca cloth, Toray Ind. Inc.) or a carbon paper sheet (TGP-H-060, Toray Ind. Inc.). The water-repellent layer 72 is formed of a mixture prepared by mixing carbon powder, water-repellent particles, water-repellent fibrils or fibers and, for example, a polytetrafluoroethylene resin.

The anode diffusion layer 70a is a conducting, porous woven or nonwoven fabric of carbon fibers, such as a carbon cloth (Toreca cloth, Toray Ind. Inc.) or a carbon paper sheet (TGP-H-060, Toray Ind. Inc.). The anode diffusion layer 70a has a function of promoting the feed of the fuel solution and the quick dissipation of carbon dioxide gas produced in the fuel cell. In order to suppress the growth of bubbles of carbon dioxide gas produced at the anode in the porous carbon substrate 71a and in order to enhance the output density of the fuel cell, the following methods are effective. That is a method of giving a porous carbon substrate 71a a hydrophilic nature by moderately oxidizing the porous carbon substrate 71a or by irradiating the porous carbon substrate 71a with ultraviolet rays; a method of dispersing a hydrophilic resin in the porous carbon substrate 71a; and a method of dispersing a highly hydrophilic substance, such as a titanium oxide on the porous carbon substrate 71a. Suitable materials for forming the anode diffusion layer 70a are not limited to those mentioned above and substantially electrically inactive metallic materials, such as nonwoven fabrics of stainless steel fibers, porous structures of stainless steel, porous structures of titanium and porous structures of tantalum, may be used.

The above-mentioned electrolyte will be expressed concretely hereinafter referring embodiments and comparative examples. Although the catalytic metals of the embodiments are Pt—Ru alloy, it is not limited to them. The catalytic metal for cathode of a DMFC may be pt catalytic metal.

### Embodiment 1

A electrocatalyst in Embodiment 1 for the electrode of a DMFC and a method of fabricating the same will be described. A support was made of carbon black, an intermediate was made of Au, and a catalytic metal was Pt. Manufacturing method of the electrocatalyst is as follows.

A mixture prepared by mixing carbon black and a 5% perfluorosulfonic acid solution (of Arudoritchi make) was stirred for 6 h to prepare a slurry. A carbon paper sheet (Toray Ind. Inc) was coated with the slurry and the slurry coating the carbon paper sheet was dried to obtain an electrode. The perfluorosulfonic acid concentration of the slurry was 30% by weight. An intermediate was formed by depositing Au on a surface of the electrode by electroplating. A plating bath was prepared independently. The electrode was immersed in the plating bath, a fixed current was supplied such that the current density was 1 mA/cm² for a supply time of 0.05 s and a relaxation time of 10 s while the plating bath was stirred. Thus the electrode was Au plated such that the Au content thereof was 30% by weight.

A base metal UPD displacement plating is used for depositing Pt in a single-atom layer. The elect rode processed by the Au electro-deposition process was immersed in a copper sulfate solution containing 10 mM of copper sulfate. The electrode was kept at a potential shifted by 10 mV from a deposition potential toward a noble potential for a time between about 1 and about 2 min for UPD. The electrode was immersed in a sulfuric acid solution containing 10 mM of chloroplatinic acid immediately after UPD. Thus Cu deposited by UPD on the surface of Au was displaced by Pt. The solution was stirred and nitrogen was blown into the solution to remove oxygen contained in the solution.

A electrocatalyst in Embodiment 1 thus made was examined by ICP mass analysis. The electrocatalyst contained 28% by weight Au, and 7% by weight Pt (Table 1). The surface area of Pt was measured by hydrogen adsorption and desorption to determine the ratio of the number of exposed Pt atoms to the total number of Pt atoms. All the Pt atoms calculated by using measured data obtained by ICP mass analysis were exposed on the surface of the electrocatalyst. It was confirmed that all the Pt atoms of the electrocatalyst in Embbodiment 1 formed by depositing a very small amount of Pt on the Au intermediate serve effectively as catalyst.

### Embodiments 2 to 4

Electrocatalysts in Embodiments 2 to 4 had a Pd intermediate, an Ir intermediate and a Rh intermediate, respectively. Other parts of those electrocatalysts are the same as those of the electrocatalyst in Embodiment 1. Conditions of fabrication of the electrocatalysts in Embodiments 2 to 4 were the same as those of fabrication of the electrocatalyst in Embodiment 1. Results of evaluation of the characteristics of the electrocatalysts in Embodiments 2 to 4 are shown in Table 1. Those electrocatalysts, similarly to the electrocatalyst in Embodiment 1, had high Pt utilization ratios, respectively.

### Embodiment 5

A electrocatalyst in Embodiment 5 had an Ag intermediate. UPD using Cu was not used. An electrode having the Ag intermediate was immersed in a sulfuric acid solution containing chloroplatinic acid to displace Ag by Pt. Thus Pt was deposited on the surface of the electrocatalyst. Results of evaluation of the characteristics of the electrocatalyst in Embodiment 5 are shown in Table 1. This electrocatalyst, similarly to the electrocatalyst in Embodiment 1, had a high Pt utilization ratio.

### Embodiments 6 and 7

Electrocatalyst in Embodiments 6 and 7 had a support of carbon fibers (VGCF, Showa Denko) and a support of carbon nanofibers, respectively, instead of an electrocatalyst of carbon black. Conditions of fabrication of parts excluding the supports of those electrocatalysts were the same as those of fabrication of the parts of the electrocatalyst in Embodiment 1. Results of evaluation of the characteristics of the electrocatalysts in Embodiments 6 and 7 are shown in Table 1. These electrocatalysts, similarly to the electrocatalyst in Embodiment 1, had high Pt utilization ratios, respectively.

### Embodiments 8 to 10

Electrocatalysts in Embodiments 8 to 10 are provided with intermediate of nanoparticles, respectively. Au nanoparticles having a mean particle size of 20 nm, Au nanoparticles having a mean particle size of 12 nm and Pt nanoparticles having a mean particle size of 5 nm were used. A mixture of a dispersion containing 10% byweight nanoparticles and carbon black was stirred for 5 h, the mixture was filtered and dried. A carbon paper sheet was coated with a mixture prepared by mixing nanoparticle-carrying carbon black and perfluoorosulfone acid to form an electrode. The total nanoparticle content of the nanoparticle-carrying carbon black was 30% by weight. Platinum was deposited by the Pt deposition method used for fabricating the electrocatalyst in Embodiment 1. Results of evaluation of the characteristics of the electrocatalysts in Embodiments 8 to 10 are shown in Table 1. Substantially all the nanoparticles were carried. These electrocatalysts, similarly to the electrocatalyst in Embodiment 1, had high Pt utilization ratios, respectively.

### Embodiments 11 and 12

Amounts of perfluorosulfone acid contained in electrocatalysts in Embodiments 11 and 12 were 20% and 50% of carbon black, respectively. Conditions of fabrication of the electrocatalysts in Embodiments 11 and 12, excluding conditions on perfluorosulfone acid, were the same as those of fabrication of the electrocatalyst in Embodiment 1. Results of evaluation of the characteristics of the electrocatalysts in Embodiments 11 and 12 are shown in Table 1. These electrocatalysts, similarly to the electrocatalyst in Embodiment 1, had high Pt utilization ratios, respectively.

### COMPARATIVE EXAMPLE 1

A electrocatalyst in Comparative example 1 was formed by depositing Pt on a structure of carbon black by electroplating. An electrode was made by the method used for forming the electrode of the electrocatalyst in Embodiment 1. Chloroplatinic acid was deposited by the method of forming an intermediate. The Pt content of the electrocatalyst was 30% by weight. Results of evaluation of the characteristics of the electrocatalyst in Comparative example 1 are shown in Table 1. This electrocatalyst had a Pt utilization ratio of 18%.

### COMPARATIVE EXAMPLE 2

A electrocatalyst in Comparative example 2 was formed by depositing Pt on a structure of carbon black by electroless plating. A dispersion was prepared by dispersing carbon black in a sodium hydroxide solution containing chloroplatinic acid. The dispersion was reduced by using formaldehyde to deposit Pt. The Pt content of the electrocatalyst was 30% by weight. Results of evaluation of the characteristics of the electrocatalyst in Comparative example 2 are shown in Table 1. This electrocatalyst had a Pt utilization ratio of 22%.

### COMPARATIVE EXAMPLE 3

A electrocatalyst in Comparative example 3 was formed by supporting Pt nanoparticles having a mean particle size of 2 nm on a structure of carbon black by the method used for fabricating the electrocatalysts in Embodiments 8 to 10. The Pt content of the electrocatalyst was 31% by weight. Results of evaluation of the characteristics of the electrocatalyst in Comparative example 3 are shown in Table 1. This electrocatalyst had a Pt utilization ratio of 25%.

TABLE 1

| | Pt Content | Pt Utilization |
|---|---|---|
| | (% by wt.) | ratio (%) |
| Embodiment 1 | 7 | 100 |
| Embodiment 2 | 5 | 95 |
| Embodiment 3 | 6 | 98 |
| Embodiment 4 | 5 | 93 |
| Embodiment 5 | 6 | 90 |
| Embodiment 6 | 8 | 89 |
| Embodiment 7 | 7 | 98 |
| Embodiment 8 | 10 | 80 |
| Embodiment 9 | 4 | 85 |
| Embodiment 10 | 5 | 92 |
| Embodiment 11 | 10 | 90 |
| Embodiment 12 | 8 | 88 |
| Comparative example 1 | 30 | 18 |
| Comparative example 2 | 30 | 22 |
| Comparative example 3 | 31 | 25 |

### Embodiment 13

Electrodes carrying a very small amount of Pt and Pt—Ru were fabricated by the method used for fabricating the electrode of the electrocatalyst in Embodiment 1. A fuel cell including those electrodes was assembled. A fuel cell 1, namely, a DMFC, in a preferred embodiment according to the present invention employing a electrocatalyst according to the present invention for a personal digital assistant will be described.

Referring to FIG. 6 showing the fuel cell module 1, namely, the DMFC module, has a fuel chamber 12, MEAs not shown, provided with an electrolyte of sulfomethylated polyether sulfone, a cathode end plate 13c, an anode end 13a, a gasket sandwiched between the cathode end plate 13c and the anode end plate 13a. The MEAs are mounted on only one side of the fuel chamber 12. A fuel feed pipe 28 is attached to a side surface of the fuel chamber 12 and a gas exhaust port 4 is formed in another side surface of the fuel chamber 12. A pair of output terminals 3 is attached to peripheral parts of the anode end plate 13a and the cathode end plate 13c, respectively. The fuel cell module 1 is identical in construction and component parts with the fuel cell module 1 shown in FIG. 2. The fuel cell module 1 shown in FIG. 6 differs from the fuel cell module 1 shown in FIG. 2 in that a power generating module is mounted on only side of the fuel chamber 12 and the fuel chamber 12 is not provided with a fuel cartridge holder. The fuel chamber 12 is formed of a high-pressure vinyl chloride resin, the anode plate 13a is a polyimide resin film and the cathode plate 13c is a glass fiber reinforced epoxy resin sheet.

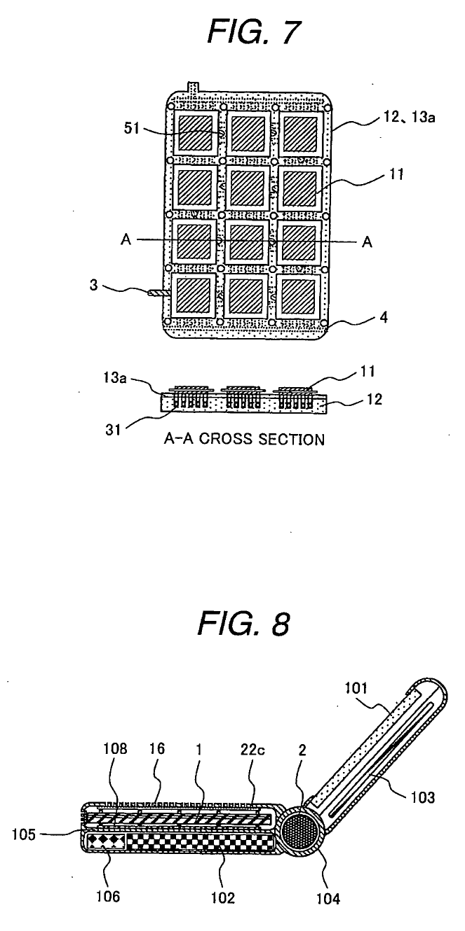

FIGS. 7A and 7B are a plan view and a sectional view, respectively, of the fuel cell module 1 as DMFC. FIG. 7A shows the layout of the twelve MEAs 11 of 22 mm×24 mm each having an electrode of 16mm×18 mm. The twelve MEAs 11 with diffusion layer and fuel feeder 31 are installed in slits formed in the surface of the anode end plate 13a attached to the fuel chamber 12. A current corrector, not shown, is bonded to the anode plate 13a such that the outer surface thereof is flush with the outer surface of the anode plate 13a. The MEAs are connected in series to the output terminals 3 by interconnectors 51.

The size of a power supply thus fabricated is 115 mm×90 mm×9 mm. The MEAs forming the power generating section of the fuel cell module 1 are provided with electrocatalysts similar to the electrocatalyst in Embodiment 1. The fuel cell 1 of the present invention, as compared with conventional DMFCs, has a high output capacity.

### Embodiment 14

FIG. 8 shows a personal digital mobile provided with the fuel cell module 1 in Embodiment 13. The personal digital mobile includes a display 101 with a touch panel type input device, a built-in antenna 103, a first case containing the display 101 and the antenna 103, a main board 102, and a second case containing the lithium ion secondary battery 106 and the main board 102. The main board 102 is provided with the fuel cell module 1, electronic devices and electronic circuits including a processor, volatile and nonvolatile memories, a power controller, a fuel cell and secondary battery hybrid controller and a fuel monitor, a lithium ion secondary battery 106. The fuel cartridge 2 is contained in a hinge 104 serving also as a fuel cartridge holder. The first and the second case are connected by the hinge 104 so as to be foldable.

A power unit is separated from the other parts by a partition wall 105. The main board 102 and the lithium ion secondary battery 106 are disposed in a lower part of the power unit. The fuel cell 1 module is disposed in an upper part of the power unit. Slits 22c are formed in the upper and side walls of the second case to discharge air and gases produced by the fuel cell 1 and the wall 105 is coated with an absorptive, quick-drying sheet 108.

The MEAs forming the power generating section of the fuel cell 1 is incorporated into the personal digital mobile are provided with the electrocatalysts similar to the electrocatalyst in Embodiment 1 and the fuel cell module 1, as compared with conventional DMFCs, has high output capacity. A maximum output that can be needed by the personal digital assistant can be increased.

Although the invention has been described in its preferred embodiments with a certain degree of particularity, obviously many change and variations are possible therein. It is therefore to be understood that the present invention may be practiced otherwise than as specifically described herein without departing from the scope and spirit thereof.

What is claimed is:

1. An electrocatalyst for an electrode in a fuel cell, comprising: a support, a catalytic metal particle supported on the support, an intermediate made of a metal different from Platinum formed on the support, and a solid polymer electrolyte layer formed on the support;wherein the catalytic metal particle is attached on an exposed surface of the intermediate.

2. The electrocatalyst according to claim 1, wherein the catalytic metal particle is in metallic bond with the intermediate.

3. The electrocatalyst according to claim 1, wherein the catalytic metal particle is Pt or a Pt-containing alloy, and the content thereof is in the range of 1 to 50% by weight.

4. The electrocatalyst according to claim 1, wherein the metal forming the intermediate is at least one of Pd, Rh, Ir, Ru, Os, Au, Ag, Ni and Co.

5. The electrocatalyst according to claim 1, wherein the intermediate is supported on the support by physical adsorption or by chemical bond of the intermediate and functional groups lying on the surface of the support.

6. The electrocatalyst according to claim 1, wherein the weight of the intermediate is between 10 to 60% of the total weight of the electrocatalyst.

7. The electrocatalyst according to claim 1, wherein the ratio of the number of atoms of the catalytic metal particle determined by a chemical gas adsorption measuring method, is between 50 to 100 to the total number of atoms of the catalytic metal particle contained in the electrocatalyst.

8. The electrocatalyst according to claim 1, wherein the solid polymer electrolyte has a proton-conducting property and is supported on the support by physical adsorption; and the ratio of the weight of the solid polymer electrolyte to a total weight of the electrocatalyst is between 10 and 60 wt %.

9. The electrocatalyst according to claim 1, wherein the support is made of a carbonaceous material.

10. A membrane-electrode assembly comprising: an anode, a cathode, and a solid polymer electrolyte sandwiched between the anode and the cathode,
wherein at lest one of the anode and the cathode includes a support, a catalytic metal particle, an intermediate of a metal different from Platinum, and a solid polymer electrolyte, and
wherein the intermediate and the solid polymer electrolyte are supported on the support, and the catalytic metal particle is formed on exposed parts of the surface of the intermediate.

11. A fuel cell comprising:
a membrane-electrode assembly including an anode, a cathode, and a solid polymer electrolyte sandwiched between the anode and the cathode; and the membrane-electrode assembly configured that a fuel is fed to the anode and air is fed to the cathode;
wherein at lest one of the anode and the cathode includes a support, a catalytic metal particle, an intermediate of a metal different from Platinum, and a solid polymer electrolyte, and
wherein the intermediate and the solid polymer electrolyte are supported on the support, and the catalytic metal particle is formed on exposed parts of the surface of the intermediate.

12. The fuel cell according to claim 11, wherein the fuel is at least one of hydrogen and a hydrocarbon compound.
